(19) United States
(12) Patent Application Publication
(10) Pub. No.: US 2017/0193531 A1
(43) Pub. Date: Jul. 6, 2017

(54) Intelligent Digital Media Content Creator Influence Assessment

(71) Applicant: BroadbandTV, Corp., Vancouver (CA)

(72) Inventors: Mehrdad Fatourechi, Vancouver (CA); Ehsan Vahedi, Vancouver (CA); Di Xu, Vancouver (CA)

(21) Appl. No.: 15/387,434

(22) Filed: Dec. 21, 2016

Related U.S. Application Data
(60) Provisional application No. 62/273,207, filed on Dec. 30, 2015.

(51) Int. Cl. G06Q 30/02; G06Q 50/00; G06F 17/30

(52) U.S. Cl. CPC G06Q 30/0201; G06F 17/30867; G06F 17/3084; G06F 17/30817; G06Q 50/01

(57) ABSTRACT

In accordance with one embodiment, a market influence analysis engine assesses the potential market influence of digital media content items and/or the influence of associated content creators. The market influence analysis engine identifies digital media content items associated with at least one user-provided content descriptor, sorts the identified digital media content items into different groups such that the digital media content items in each group are associated with a different one of the plurality of content creators. The market influence analysis engine further calculates an influence score associated with each one of the content creators that is based on consumer influence metrics. A subset of the groups for which the calculated influence score satisfies a predetermined influence threshold is identified and information representing such groups is transmitted for presentation to a user interface.

This application claims the benefit under 35 U.S.C. §119(e) to U.S. provisional patent application 62/273,207, titled “System and Method of Digital Content Search and Brand Analysis,” and filed on Dec. 30, 2015, which is hereby incorporated by reference all that it discloses or teaches.

### BACKGROUND

Nowadays, millions of content creators create content on digital sharing websites including but not limited to YouTube®, ^{Snapchat}®, Twitter®, Facebook®and Instagram®. Some of these content creators create content that is more engaging and appealing to a larger user base than others. Consequently, some content creators may have a larger follower base that engages more users as compared to the content creators who create less engaging content or content that is appealing to less users. As the follower base grows for a particular content creator, the content creator's level of user influence may grow as well. As an example, a content creator with tens of thousands of followers (e.g., viewers who follow the activities of that content creator on a digital media platform such as YouTube) may have an impact on the opinion or the decision-making power of some of his or her followers. Due to this influence, such a content creator is considered to be an “influencer”.

Brands or organizations may be interested in finding influencers, such as content creators on digital media sharing websites that have a high potential to positively or negatively influence public opinion. Brand representatives, product distributors, and other individuals may also wish to objectively evaluate marketing strategies on digital media sharing websites (e.g., social media outlets), such as to compare online presence and marketing strategies between different products and brands. Existing technologies generally do not offer comprehensive or automatic solutions to discover influencers. Instead, brands and organizations have to rely on manual search and/or referrals to find influencers which is a tedious and time-consuming task and is not scalable.

### SUMMARY

Implementations described herein address the foregoing by providing systems and methods for identifying digital media content items relevant to a user search and assessing the potential market influence of content creators responsible for initiating publication of such items. According to one implementation, a market influence analysis engine identifies digital media content items associated with at least one user-provided content descriptor, identifies the corresponding content creator for each digital media content, calculates an influence score associated with each content creator and sorts the content creators based on consumer influence metrics. A subset of the content creators for which the calculated influence score satisfies a predetermined influence threshold is identified and information representing such groups is transmitted for presentation to a user interface or other use.

### BRIEF DESCRIPTION OF THE DRAWINGS

A further understanding of the nature and advantages of the present technology may be realized by reference to the figures, which are described in the remaining portion of the specification.

FIG. 1 illustrates one example system for digital content search and market influence analysis.

FIG. 2 illustrates another example system for digital content search and market influence analysis.

FIG. 3 illustrates example operations for using a system for digital content search and market influence analysis.

FIG. 4 illustrates example operations for identifying influential content creators with respect to a particular product, brand, platform, or idea.

FIG. 5 discloses a block diagram of a computer system suitable for implementing one or more aspects of a system for digital content search and market influence analysis.

### DETAILED DESCRIPTION

The herein disclosed technologies provide tools that facilitate efficient digital content searches and provide sophisticated analysis techniques for objective assessment of market influence of a digital media content creator based on a variety of factors such as but not limited to the quality and the type of content source, traffic associated with the content and/or the content source, detectable user engagement signals, and more. Such information can be also useful in a variety of ways including evaluation of existing market influence of a product or brand and in helping to improve market influence and/or control how a product, brand, or idea is perceived by a key demographic of online users. Accordingly, the disclosed technology can be utilized by digital media content creators to measure a content creator's own market influence with respect to a particular product or brand and/or used by marketing representatives to identify content creators that may be good candidates for future marketing collaboration.

As used herein, the term “content creator” refers to a party that performs an action to initiate publication of a digital content item. For example, a content creator may be a user that uploads a video, text, image, etc. to a digital media sharing website, to a personal website, company website, etc. In cases where the digital content items are viewable on a digital media sharing website (e.g., YouTube®, Vimeo®, Flickr®, SoundCloud®, etc.), the “content creator” (also referred to herein as the “publisher”) is the individual or entity that initiates publication rather than the third-party provider (e.g., youtube.com) that enables it.

Content creators that are also effective influencers for a specific brand, product, organization, type of content, etc., may be identified based on a variety of factors. One important factor is user base size (e.g., viewer base size for a digital video platform such as YouTube). For example, a content creator may be an effective influencer if he or she has a large follower base and/or a high level of user engagement (e.g., user comments, re-shares, likes/dislikes). Another important factor is suitability. For example, a content creator that creates favorable videos about Apple products® may not a good match for being an influencer for a competing company such as Microsoft®. On the other hand, a content creator who creates videos critical of Apple products or favorable videos of Microsoft may be a good candidate for collaboration with Microsoft marketing personnel.

Finding an influencer (amongst millions of content creators) who may be a good match for a brand or product is a challenging task. There are various factors that a particular brand might be looking for in an influencer. Examples include but are not limited to finding content creators with a large follower base who create content with positive sentiment about that brand, negative sentiment about the competing brands, content that is relevant to the space that the brand is focusing on, and content that is of high quality, such as content that lacks vulgarity and/or content that is sexually-suggestive. As such, there is a need for a system that automatically finds and recommends influencers that have the potential to collaborate with a brand and represent the brand, products, or other ideas being presented to a wide audience.

In one implementation, the disclosed technology facilitates identification and/or ranking of potentially effective influencers (also referred to herein as “brand or product ambassadors”) for promoting a particular type of content. For example, effective influencers may be digital content creators with a demonstrated influence on a particular customer base that may be potentially influential collaborators for a particular marketing campaign. Similarly, the disclosed technology may be useful in identifying effective social or political ambassadors, such as to promote a particular social or political platform. In order to locate these influencers and their associated channels of influence (including but not limited to YouTube channels, Twitter, Snapchat, Instagram, Pinterest and Facebook accounts, RSS feeds, and social media blogs) a detailed search may be first conducted to identify digital content items relevant to a particular brand, product, marketing campaign, etc., such as items published on digital media content sharing websites including without limitation images, videos, files, text, etc. The identified digital content items may then be grouped, sorted, analyzed, and ranked based on one or more consumer influence metrics, as described in detail below.

Many of the examples discussed herein pertain to content creators in the digital video space. However, it should be understood that the same ideas can be applied to content creators of a variety of types of digital content including without limitation text, images, audio or a combination of them.

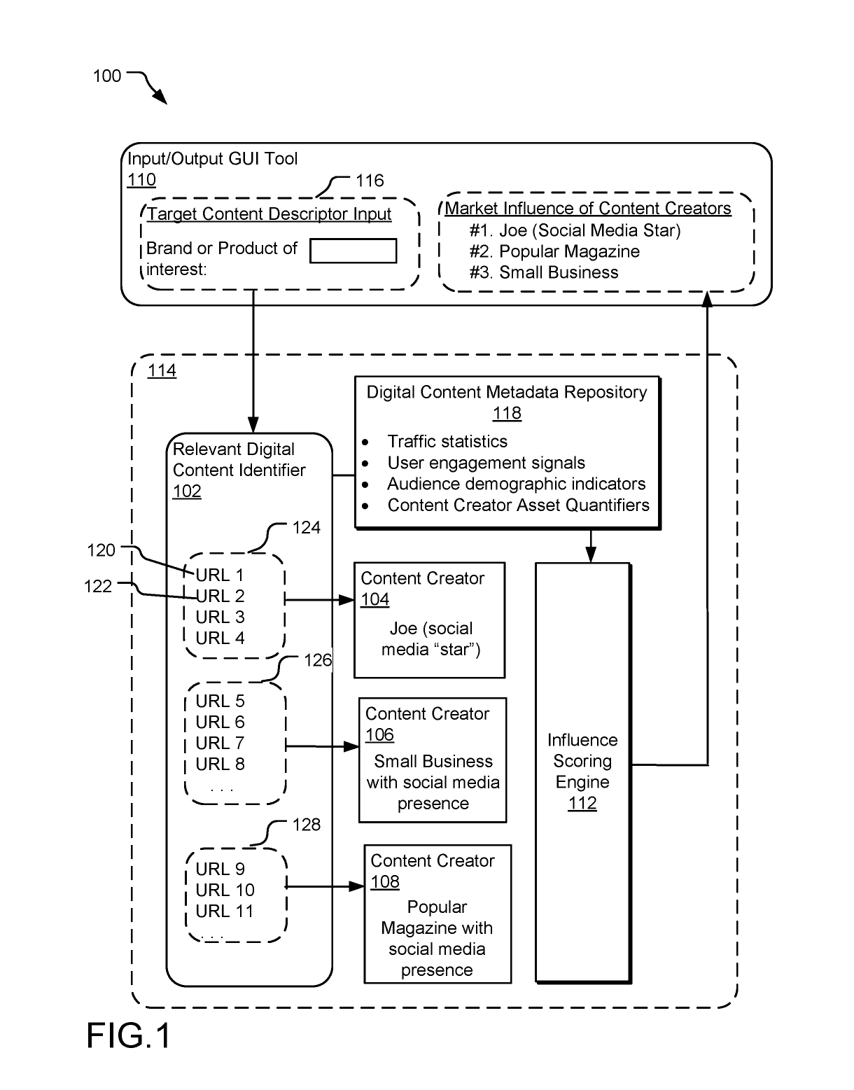

FIG. 1 illustrates one example system 100 for digital content search and market influence analysis. The system 100 includes an input/output graphical user interface (GUI) tool 110 that provides input to and receives output from a market influence analysis engine 114. The market influence analysis engine 114 further includes a relevant digital content identifier 102, a digital content metadata repository 118, and an influence scoring engine 112. These and other components of the system 100 may exist within a single network or may be distributed across any combination of networks, servers, personal devices, etc. In one implementation, the market influence analysis engine 114 resides on a centralized server, or on a cloud computing service such as Amazon Web Services or Microsoft Azure. In another implementation, the various aspects of the market influence analysis engine 114 are integrated onto one or more different computing devices that interact over a local or wide area network.

In general, the relevant digital content identifier 102 interacts with various search engines and databases to identify digital content items that are relevant to a search initiated by a user. In one implementation, a user provides the input/output GUI tool 110 with target content descriptor input 116 (e.g., one or more keywords or phrases) and the relevant digital content identifier 102 identifies digital content items that are associated with the target content descriptor input 116. For example, the target content descriptor input 116 may specify or describe a brand or product of interest and the associated digital content may include online videos, images, or other content that depicts, describes, or is otherwise representative of the brand or product of interest.

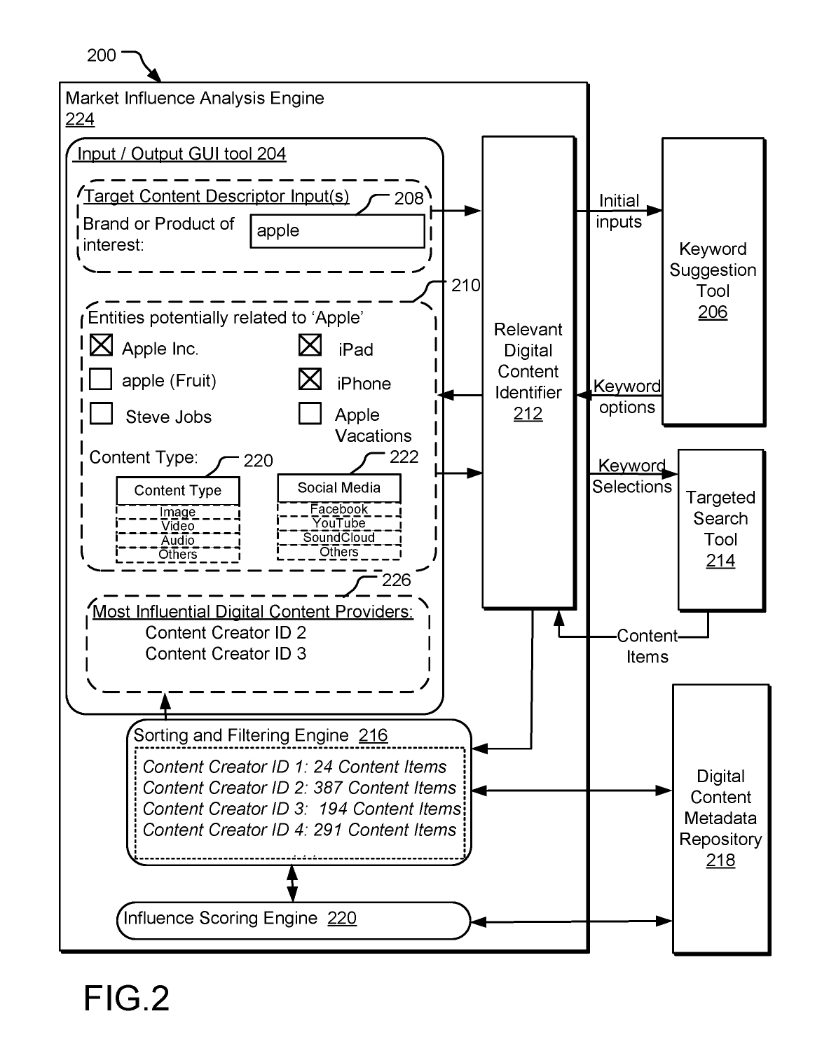

In FIG. 1, a listing of uniform resource locators (URLs) is shown within the relevant digital content identifier 102, where each URL is representative of an identified digital content item that the relevant digital content identifier 102 has identified as relevant to the target content descriptor input 116. For example, digital content items 120 (URL 1) and 122 (URL 2) may represent links to websites where the corresponding digital content items are viewable. In some implementations, the relevant digital content identifier 102 may index identified digital content items by some method other than a URL location descriptor, such as by a file path, IP address, digital asset ID, etc. In different implementations, the relevant digital content identifier 102 may use a variety of different available tools to locate and identify the digital content items (e.g., 120, 122) that are relevant to the target content descriptor input 116. Some of these tools are described in greater detail with respect to FIG. 2, below.

In performing a relevant content search, the relevant digital content identifier 102 is, in some cases, likely to find multiple relevant digital content items associated with a common content creator.

In the example of FIG. 1, a first subset 124 of the identified digital content items are associated with a first content creator 102 responsible for initiating publication of each item in the first subset 124. For example, the digital content items in the first subset 124 are videos published by a user named Joe, who is a self-made social media star with a strong social media presence on one or more digital content-sharing websites. For example, Joe may upload and share content through one or more of a YouTube channel, a Twitter account, a Facebook page, a Rich Site Summary (RSS) feed that pushes articles or other content to RSS subscribers, a blog, etc. For example, Joe may manage content on a YouTube channel that showcases different videos each week, some of which pertain to a product or brand specified by the target content descriptor input 116. A second subset 126 of the identified digital content items are associated with a second content creator 104 responsible for initiating publication of all digital content posted in the second subset 126. For example, the digital content items in the second subset 126 are uploaded to one or more social accounts in the name of a small business or small business owner. A third subset 128 of the identified digital content items are published by a third content creator 106 on behalf of a larger company, such as a popular magazine. For example, a magazine editor via of the magazine may upload and/or share content via one or more social media accounts in the name of the magazine.

The influence scoring engine 112 assesses a strength and/or type of market influence associated with the identified digital content items or, more specifically, with the individual subsets 124, 126, and 128 of the identified digital content items and the associated content creator of each of the subsets. In one implementation, this assessment entails calculation of consumer influence metrics based on metadata associated with views of the identified digital content items, viewers of the identified digital content items, and/or the content creators of such items. This metadata (also referred to herein as “digital content metadata”) is collectable from one or more sources represented in FIG. 1 by a digital content metadata repository 118. The digital content metadata repository 118 may, in different implementations, represent an actual physical repository in one or more databases and/or a channel for receiving such information from various digital media sharing websites (e.g., YouTube®, Vimeo®, Flickr®, SoundCloud®) associated with one or more different servers. In some instances, a digital media sharing website (e.g., YouTube®, Vimeo®, Flickr®,SoundCloud®)may publicly provide digital content metadata in relation to user-uploaded digital media content, such as by providing such data upon request or by publicly displaying such information in association with corresponding digital content items.

The digital content metadata available in digital content metadata repository 118 may include a variety of information including, without limitation, network traffic statistics (e.g., number of user views of each of the relevant digital content items and views of other digital content items associated with each of the content creators 104, 106, 108); user engagement signals (e.g., documented number of ‘likes’, ‘dislikes’ or ‘shares’ associated with each content item and/or content creator); audience demographic indicators (e.g., audience demographic information associated with each content item, such as the age, gender, and other demographic information attainable); and content creator asset qualifiers (e.g., available information quantifying the amount, type, influence, and/or quality of digital assets associated with a particular content creator).

Using information in the digital content metadata repository 118, the influence scoring engine 112 assesses a market influence related to the identified digital content items, such as a market influence attributable to the individual subsets 124, 126, and 128 of digital content items and/or a market influence of the associated content creators 104, 106, and 108. In one implementation, the influence scoring engine 112 calculates an influence score associated with each one of the content creators 104, 106, and 108. The influence score is, in general, a quantification or measure of influence (e.g., indicating high influence, low influence, good influence, bad influence) that the associated digital content items (e.g., 120, 122) and/or content creators 104, 106, and 108 have on a viewer demographic. In at least one implementation, the influence score is based on a size of a viewer demographic as quantified based on of total views of the digital media content items.

In FIG. 1, the influence scoring engine 112 ranks the content creators 104, 106, and 108 according to the calculated influence scores and provides the input/output GUI tool 110 with the ranking or with output based on the ranking that is, in turn, displayed to a user. For example, the influence scoring engine 112 may identify a subset of the content creators 104, 106, and 108 for which a corresponding calculated influence score satisfies a predetermined threshold. Responsive to such identification, the influence scoring engine 112 provides information representative of the calculated influence score to the input/output GUI tool 110. If, for instance, three of fifteen scored content creators have an influence score satisfying a predetermined threshold, the influence scoring engine 112 may provide output information to the input/output GUI tool 110 that identifies these three content creators as being associated with a high degree of influence with respect to the brand or product of interest. In another implementation, instead of choosing influencers whose influence score is higher than a pre-determined threshold, the top N influencers in the ranking might be presented to the user, independent of what the value of each influencer score is. In FIG. 1, the input/output GUI tool 110 ranks each of the content creators 104, 106, and 108 based on metrics indicative of certain influence criteria, such as metrics representative of a magnitude of influence (e.g., large or small), a type of influence (e.g., good or bad), and/or magnitude and/or type of influence with respect to a certain target viewer demographic. This information can then be utilized by an end user to evaluate existing marketing techniques of a product or brand, to compare marketing strategies of competing products, and/or to adjust or create a marketing strategy for a particular product or brand. In another implementation, the GUI can be used by the influencer to identify which brands are suitable to the interests of that influencer and therefore the influencer can reach out and collaborate with those brands.

FIG. 2 illustrates another example system 200 for digital content search and market influence analysis. The system includes a market influence analysis engine 224 that interacts with various search engines and databases to identify digital content items relevant to a particular user query and to access associated digital content metadata. The market influence analysis engine 224 provides various tools for analyzing such information and facilitating assessment of the magnitude, quality and/or type of market influence associated with digital content items and/or with content creators of such items (e.g., individuals that initiated publication of such digital content items on either a personal domain or a digital media sharing website such as YouTube®, Snapchat®, Facebook®, Twitter®, Vimeo®, Instagram®, Flickr®, SoundCloud®, etc.).

The market influence analysis engine 224 includes an input/output GUI tool 204, a relevant digital content identifier 212, a sorting and filtering engine 216, and an influence scoring engine 220. These and other components of market influence analysis engine 224 may exist within a single network or may be distributed across any combination of networks, servers, personal devices, etc.

The relevant digital content identifier 212 receives input from the I/O tool 204 including at least one content descriptor 208 pertaining to a user query. The content descriptor 208 may, for example, include one or more words or phrases pertaining to a brand or product of interest. By example and not limitation, the content descriptor 208 may be a brand such as a soda brand (e.g., Pepsi®, Coke®), a clothing designer (e.g., Louis Vuitton®, Prada®), video game producer (e.g., Sony®, Xbox®), nutrition company (e.g., Jenny Craig®), etc. Additionally or alternatively, the content descriptor 208 may list a specific product, multiple products, features of a product, etc. In the example of FIG. 1, a user types the term “apple” with the intention of finding content creators on social media that have published digital content items relating to products by the technology company, Apple, Inc®. In one embodiment, the user also has the option of adding additional information about the type of influencer they are seeking. Examples of this additional information include but are not limited to options for restricting the search results to influencers with no vulgarity in their videos, influencers with no sexuality or nudity in their videos, and/or influencers with no suggestive sexuality in their videos.

In one embodiment, a generalized keyword search of the content descriptor 208 via a search engine of a digital media sharing web site may provide the user with thousands of results that are returned based on the search engine mechanism implemented for that particular digital media sharing web site. The mechanism of how this search engine works might vary from one digital media sharing website to next (e.g., YouTube's search mechanism is different than that of Twitter). However, a search engine's main role is to return the results that are as relevant as possible, as the usefulness of a search engine depends on the relevance of the result set it gives back. As such, it is expected that the returned results are relevant to the search query, although the degree of relevancy might vary depending on multiple factors such as the specific query that was searched and also the rank of the returned result.

To find the digital content relevant to the intended context of the content descriptor 208, the relevant digital content creator 212 may, in some implementations, provide the user-supplied input (e.g., “apple” in the illustrated example) to a keyword suggestion tool 206 usable to identify potentially useful keyword terms for narrowing a search.

In one particular implementation, the keyword suggestion tool 206 utilizes a knowledge base (KB) such as Wikidata or YAGO to identify keywords to better define the intended scope of a digital content search. A KB system may, for example, include a large database representing facts about the world, and further include an inference engine that can draw conclusions about those facts using rules and other forms of logic to deduce new facts or highlight inconsistencies. Typical KB systems store, organize, and interrelate millions (or sometimes billions) of items referred to as “entities.” Entities that are somehow related to each other in real world are connected in the knowledge base. For instance, in an example search for a movie, entities connected in the knowledge base system 206 may include the name of the movie, the name of the director, actors and actresses, etc.

In other implementations, the keyword suggestion tool 206 does not utilize a KB system. For example, the keyword suggestion tool 206 may access various databases to identify keyword suggestions potentially relevant to the user-specified content descriptor 208. Still other implementations do not include the keyword suggestion tool 206. For example, the user may provide the input/output GUI tool 204 with a complete list of keywords on which to perform a targeted search.

In the illustrated example, the input/output GUI tool 204 presents the user with the suggested keyword terms (e.g., entity descriptors): “Apple, Inc.”, “apple (fruit)”, “Steve Jobs” (e.g., the former CEO of Apple), “iPad” and “iPhone” (e.g., popular products of Apple), and “Apple Vacations.” In some implementations, the user may be presented with a much longer (or shorter) list of keyword suggestions than that shown in FIG. 2 The user selects the suggested keywords that are relevant to the search. In the illustrated example, a user selects a checkbox selecting the keywords corresponding to “Apple Inc.” and for the apple products “iPhone” and “iPad.” In some implementations, these selected keywords are provided back to the keyword suggestion tool 206 to expand the search, and the relevant digital content identifier 212 returns additional potentially relevant keywords to the input/output GUI tool 204, permitting the user to select additional keywords. This process may be repeated any number of times until the user is satisfied with the selection of keywords on which the digital content search will be based.

After receiving input that the selection of keywords is finalized, the Input/Output GUI tool 204 provides the selection of keywords to a targeted search tool 214. The targeted search tool 214 provides digital content searching of one or more databases pertaining to one or more digital media sharing websites. In some implementations, the input/output GUI tool 204 allows the user to indicate a selection of a type of content sought and/or a type of databases or specific digital media content sharing websites on which to execute the search. For example, the input/output GUI tool 204 provides the user with a selection of content type 220 (e.g., only search digital media sharing websites with video or image content) and also allows the user to select one or more domain sources 222 (e.g., digital sharing websites such YouTube and Facebook) on which to execute the search.

Although the examples of domain sources 222 provided in FIG. 2 are social media websites, other implementations may allow the user to select one or more domains for the search that are not social media websites. For example, the user may elect to search content posted on popular domains, such as www.wired.com (owned by the tech magazine “Wired”) or www.pcmag.com (owned by the tech magazine “PC Magazine”). This type of search may be beneficial when, for example, a user seeks to determine how favorably these different domains and/or their associated publications reflect upon the brand or product of interest.

The targeted search tool 214 returns a listing of relevant content items (e.g., content associated with one or more of the user-specified keywords) to the relevant digital content identifier 212, which in turn provides an indexing of those items to a sorting and filtering engine 216. For example, the sorting and filtering engine 216 may be provided with a list of URLs, titles, content creators, and/or other content-identifying information.

The sorting and filtering engine 216 performs sorting and filtering operations that vary in different implementations. In one implementation, the sorting and filtering engine 216 sorts the indexed listing of relevant digital content items based on a content creator identifier associated with each one of the digital content items. For example, the digital content items are aggregated into groups where each one of the groups is associated with a single common content creator. Content creator identifiers may be attained either from the targeted search tool 214 (e.g., along with the original indexed listing of relevant digital content items) or separately attained via a query to a digital content metadata repository 218.

In another implementation, the sorting and filtering engine 216 filters groups of associated digital content items based on an initial assessment of relevance with respect to each content creator. If, for example, a content creator has very few associated digital content items returned via the indexing, the content creator and those associated items may be filtered from the indexing at this point in time so as to reduce computation overhead associated with computing further influence metrics, described below. Likewise, a content creator may be eliminated from the indexing if a low percentage of the content creator's own digital content items are returned via the indexing.

In another implementation, the sorting and filtering engine 216 assigns each content creator an initial relevancy score based on an estimated size of the content creator's online following and/or the amount of relevant content created by the content creator. This score is usable to identify content creators with a low relevance (e.g., a small following) and to eliminate these content creators from consideration by the influence scoring engine 220.

In some implementations, the sorting and filtering engine 216 may also perform quality-based sorting, such as to identify digital content items that may include offensive or vulgar content and to eliminate the associated content creators from consideration by the influence scoring engine 220. A company searching for a potential market influencer for advertising a certain product may not be interested in collaboration with content creators that frequently post vulgar items and/or that use foul language. As an example, a company like Disney may not want a blogger or a content creator on YouTube that uses foul language to be an influencer for them.

In one implementation, the user can provide the input/output GUI tool 204 with input(s) indicting that they wish to filter the results to remove content creators that utilize foul language. The sorting and filtering engine 216 may then automatically determine if the content has vulgarity and foul language and exclude the content creators that use such language from being returned in final results from the influence scoring engine 220. As an example, in one implementation, the sorting and filtering engine 216 might use a dictionary of inappropriate words from different languages to search the text and flag the content if matches are found (or the number of matching words is higher than a certain threshold). In one implementation for digital video platforms, the sorting and filtering engine 216 can search the title, description and keywords of the video to determine a match. In yet another implementation, the system might extract and transcribe the audio of the video first and then search for the inappropriate keywords using the dictionary of bad words.

In addition to foul language, a company searching for a potential influencer for advertising a certain product may also be uninterested in collaboration with content creators that frequently post content items with a large presence of sexuality, nude pictures or nude video clips. As an example, a company like Apple, Inc. might not want a blogger or a content creator on YouTube who has nudity on their content to be associated with them. In one implementation, the user can provide the input/output GUI tool 204 with input(s) indicting that they wish to filter the search results to remove content creators that post digital content items including sexuality or nudity. The sorting and filtering engine 216 might then automatically determine if the content has nudity and/or sexuality and exclude the content creators that create such content from being presented in the search results. As an example, in one implementation, the sorting and filtering engine 216 utilizes a ratio of skin-colored pixels in each frame of a video to the total number of pixels on that frame to determine how much skin is shown in that frame. If the ratio is higher than a pre-determined threshold (Th_{NudityFrame}), then the frame is considered to potentially have nudity. If the percentage of frames in the video that Th_{NudityFrame} is higher than a certain predetermined threshold (Th_{NudityFrame}), Video then the video is flagged as a video that contains nudity and the content creator may be excluded from appearing in the results presented to the user via the influence scoring engine 220.

The sorting and filtering engine 216 provides the filtered subsets of digital content items and associated content creator identifiers to the influence scoring engine 224, and the influence scoring engine 224 accesses digital media content metadata in the digital content metadata repository 218 to compute various metrics and to assign an influence score to each associated content creator identifier.

The digital content metadata repository 218 includes various information, such as network traffic statistics, user engagement signals, audience demographic indicators, and content creator asset qualifiers (examples for each of these terms are provided above with respect to FIG. 1). In computing an influence score for a given content creator, the influence scoring engine computes one or more metrics based on the available information in the digital content metadata repository. Metrics that may factor into the influence score include one or more traffic metrics, digital asset metrics, user engagement metrics, audience qualifier metrics, and user engagement metrics. Examples of each of these metrics are provided briefly below.

As used herein, ‘traffic metrics’ refers to metrics pertaining to network traffic, such as metrics quantifying the number or frequency of views of a particular digital media content item or other items associated with a particular content creator (e.g., with an account of a content creator on a digital media sharing website).

“Digital asset metrics,” in contrast, is generally used herein to refer to metrics quantifying the amount, type, influence, and/or quality of digital assets associated with a particular content creator. For example, various asset metrics may describe the total number of ‘assets’ (e.g., digital media content items, such as videos, images, or sound clips) for which the content creator has initiated publication; the fraction of these assets that are deemed relevant to the content descriptor 208; or the average size, duration, and/or quality of digital media assets associated uploaded by a content creator. The influence scoring engine 224 may, in some implementations, compute a “production metric” that quantifies a frequency at which the digital media assets are uploaded by each individual content creator.

In other implementations, the digital content metadata repository 218 includes information indicating user engagement signals (e.g., information reflecting a user's sentiments with respect to the digital content such as information about ‘likes’, ‘dislikes’, user comments, shares or re-shares, etc.). The influence scoring engine 220 may therefore compute a user engagement metric in association with each content creator identifier. If, for example, Joe has a YouTube channel that receives a large number of “dislikes”, this may be quantified by a user engagement metric generally indicating that the YouTube channel has a negative influence on the brand or product of interest. In another implementation, the influence scoring engine 220 parses textual content associated with each digital content item content (e.g., title, summary, keywords, transcription of the audio) for certain pre-defined terms that may indicate positive or negative influence. The magnitude of this positive or negative influence may be represented by the user engagement metric.

In addition to traffic metrics, digital asset metrics, and user engagement metrics, the influence scoring engine may further compute one or more audience qualifier metrics in association with each content creator. An audience qualifier metric may, for example, qualify the size or demographic of content viewers. For example, the influence scoring engine 224 may compute one or more audience qualifier metrics based on digital content metadata pertaining to audience demographic information such as the age and gender of those that have viewed the various digital media content items and/or the other publications by the content creator.

Using digital content metadata from the digital content metadata repository 218, the influence scoring engine 224 ‘scores’ each subset of sorted digital content items and returns information representative of the influence scores to the input/output GUI tool 204. In one implementation, the influence scoring engine 224 compares calculated influence scores to one another and/or to a predetermined threshold to provision a list 226 of the most influential content creators), such as a list 226 ranking content creator identifiers in a manner indicative of a relative corresponding degree of influence that each content creator has with respect to the product or brand on which the search is based. The list 226 may indicate relative types of influence (e.g., positive influence, neutral influence, negative influence) and/or indicate a magnitude of the influence. In one implementation, the list 226 includes content creator identifiers for which a corresponding influence score satisfies a predetermined criterion (e.g., high influence or low influence).

Outputs from the market influence analysis engine 214 can be used to find content creators that create digital media content about specific products, brands, ideas, etc. and/or used to assess how different competing products or brands are influenced by digital media content. For example, the above-described technology can be utilized to rank creators of YouTube channels that have posted video content pertaining to the brand or product(s) of interest. The highest-ranked channel creators may, for example, represent potential brand and/or product ambassadors as well as influential content creators avidly uploading content about a particular industry. In another implementation, the above-described market influence analysis engine 214 can be used to determine what portion of influential content on a digital media sharing website is devoted to a brand in comparison to brands that market competing products (e.g. Apple's smartphones vs Samsung's smartphones). For example, one might utilize this technology to determine that there are a far greater number of content creators that upload content on a particular digital media sharing website that pertains to Apple products than Microsoft products.

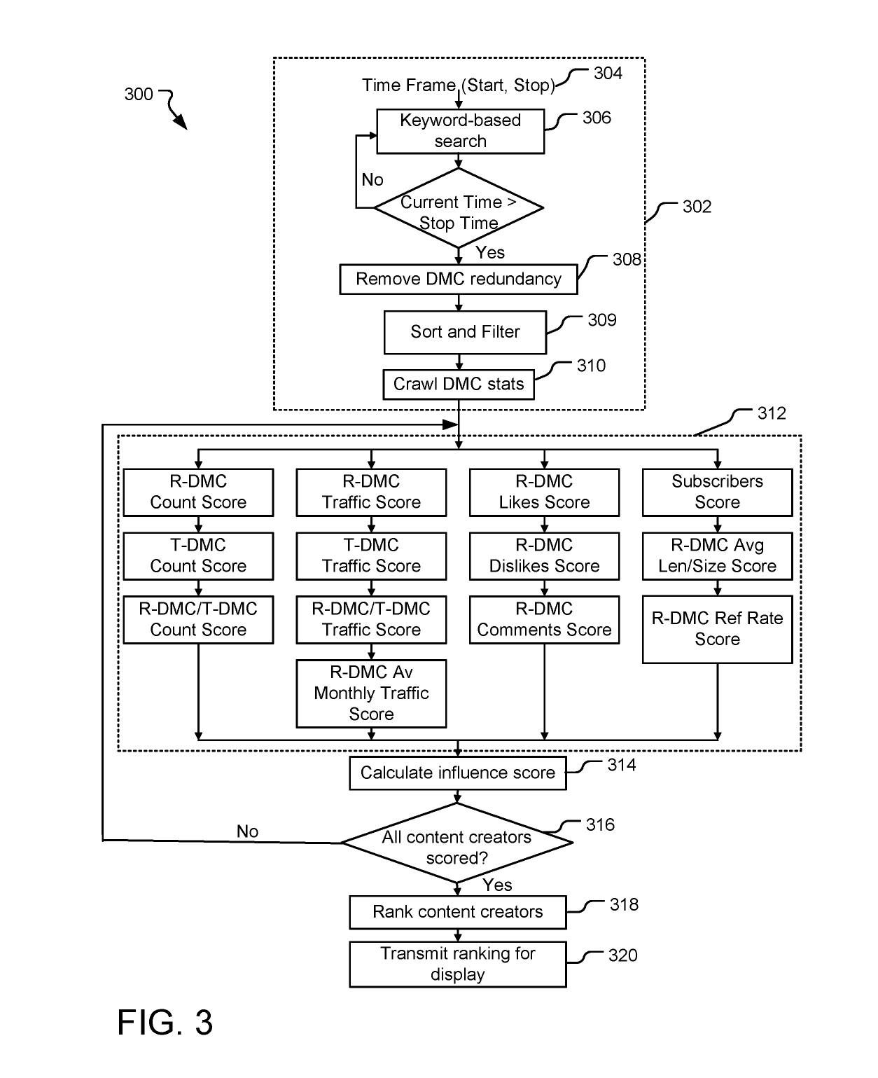

FIG. 3 illustrates example operations 300 for using a system for digital content search and market influence analysis. In a first subset of operations 302 a search is performed to identify digital media content items (e.g., abbreviated as “DMC”) that is relevant to a content descriptor provided by a user and available on one or more digital media sharing websites.

Some implementations include an interval specification operation 304 that prompts a user to specify a time interval of interest for the search. For some digital media sharing websites, such as YouTube, the accuracy of the crawling (searching) process depends on the time-frame (window) of the search. For example, some application programming interfaces (APIs) return a limited number of results at one request. In such cases, therefore, a search over a large time interval (e.g., 1 year) may be performed by breaking down the time interval into smaller intervals (e.g., two weeks) and by initiating multiple repeated queries that each cover a different sub-interval of the large time interval of interest. For example, this method may be used to retrieve YouTube videos posted during a first interval (e.g., day A and day A+13), a second interval (e.g., between day A+14 and A+27 ), etc.

A search operation 306 conducts keyword-based search of one or more digital media sharing websites for the time interval of interest. In one implementation, the keyword-based search is conducted in a manner the same or similar to that described above with respect to FIG. 2. For example, the keyword-based search may include initial operations for identifying relevant search terms and a subsequent targeted search operation that searches one or more digital media sharing websites of interest to for content associated with (e.g., indexed by) one or more of the identified relevant search terms (e.g., as described with respect to functions of the targeted search tool 214 in FIG. 2).

In some implementations, the user may narrow a search of digital media content sharing websites by specifying a specific type of content item of interest (e.g., images, videos, audio, text) and/or by specifying one or more specific digital media sharing websites on which to perform the search. The keyword-based search returns a list of relevant digital media content items (abbreviated in FIG. 3 as R-DMC), such as URL links to the relevant digital media content items. For example, a search pertaining to the technology company Apple, Inc. may lead to identification of R-DMC items pertaining to the Apple brand and other Apple brand products and services such as iPhone (all models including 3, 3s, 4, 4s, 5, 5s, 6, 6s, 6 Plus) iPad (all models), iPod (all models), iMac (all models), MacBook (all models), MacBookPro (all models), iCloud, iTunes, etc.

After the keyword-based search operation 306, a determining operation determines whether there are remaining time intervals to search. If so, the interval specification operation 304 and searching operation 306 are repeated until a search has been performed for all intervals of interest.

A redundancy removing operation 308 removes redundancies from the resulting list of search results (the R-DMC items). If, for example, the same video, audio, or image appears in the list more than once, the duplication may be removed. A sorting and filtering operation 309 sorts the R-DMC items into different groups such that items in each group are associated with a common content creator. In some implementations, certain groups are eliminated (filtered out of the R-DMC listing) if they include less than a threshold amount of the R-DMC items (e.g., some percentage of all identified R-DMC items returned related). Additionally, one or more groups may be eliminated from the R-DMC listing if any digital content items in the group fail to satisfy one or more user-specified quality-assurance factors, such as factors pertaining to vulgarity, profanity, and nudity. In some implementations, the R-DMC listing is further filtered based on image quality standards. If, for example, associated video or images are of a low resolution that fails to satisfy a minimum resolution standard, those resolution digital content items may be filtered from the R-DMC listing.

In some implementations, the order of the various filtering and computing operations (e.g., 309 and 312 ) is different than that described above. For example, some of the metrics described below with respect to a computing operation 312 may be computed initially and used in the sorting and/or filtering, such as to serve as a filtering parameter in removing certain content creators from consideration. In one implementation, the sorting and filtering operation 309 filters based on one or more of a size of a user base for a particular content creator (e.g., eliminating content creators from consideration that do not have a follower base of a minimum threshold size or only select the Top N content creators regardless of their follower base). In another implementation, the sorting and filtering operation 309 filters based on a quantity of relevant digital content items uploaded by each content creator or based on a percentage of a content creator's total uploaded content items that are relevant (e.g., eliminating content creators from consideration that have not published a threshold number or percentage of relevant digital content items). In some implementations, filtering based on a follower base size or number of relevant digital content items is performed prior to filtering based on one or more of the quality-assurance factors described above.

When filtering is performed based on one or more of these additional factors, the sorting and filtering operation 309 may compute one or more of the metrics described below with respect to computing operations 312. Initial filtering based on or more of these metrics can reduce total processing overhead and improve efficiency of the other computing operations 312.

A crawling operation 310 crawls (searches) statistics (e.g., metadata) available in association with each of the R-DMC items. Information provided by the crawling operation 310 may be the same or similar to the metadata described with respect from FIG. 2. (above) that is retrieved from the digital content metadata repository. For example, the crawling operation 310 may retrieve metadata information associated with each digital media content item such as the title, category, viewership traffic such as monthly and lifetime data, like counts, dislike counts, comment counts, content size, etc.

After identifying the R-DMC items via the subset of operations 302, the data retrieving via the crawling operation 310 and/or the listing of R-DMC items is input to a computing operation 312, which computes a set of consumer influence metrics to score for each digital content item and/or score each content creator associated with one or more of the R-DMC items. Resulting scores (e.g., the computed metrics) computed by the computing operation 312 can be analyzed to assess the presence of a brand or product on one or more digital media sharing websites and/or to identify influential content creators with respect to a product or brand. Additionally, these scores can be used to compare a brand with its competitors or to compare a product of that brand with competing products associated with other brands.

The individual score blocks or “metrics” shown in FIG. 3 (e.g., within the block indicating computing operation 312 ) may be computed differently in different implementations. For example, some implementations may be designed to specifically assess the influence of individual R-DMC items or groups of items, while other implementations may assess the influence of different content creators who have published one or more of the R-DMC items. In one implementation, a sorting operation (not shown) sorts the identified digital content items into different groups, where each group includes exclusively digital content items uploaded by a common content creator. Scores are then generated by computing each metric (e.g., a score for each depicted box) with respect to each different content creator. Other implementations may compute scores for less than all of the score blocks shown in FIG. 3. Other implementations may take into account additional metrics not described herein.

The various score blocks shown in FIG. 3 are meant to be exemplary of possible metrics that may factor into an influencer assessment. These score blocks may be utilized in any combination. Some implementations of the disclosed technology may utilize a single score block; other implementations utilize a combination of the score blocks and/or one or more other score blocks not shown or described herein. Each of the score blocks represented in FIG. 3 can be calculated using different distribution functions including, but not limited to, Long Tail, Log-Cauchy, Log-Normal, Gamma, Exponential or polynomial distributions or using methods including but not limited to solving an optimization problem, either convex or non-convex, or using bio-inspired optimization methods including but not limited to Genetic Algorithm, Genetic Programming, Ant Colony, Particle Swarm, and Pervasive Weeds. In one embodiment, a Long Tail distribution is used to calculate the one or more of these score blocks. A Long Tail function can be defined as follows in equation (1):

$$long Tail ( a , b , w , x ) = w \times min ( 1 , \frac{1}{b} {log}_{10} ( max ( 1 , \frac{x}{{10}^{a}} ) ) ) \qquad ( 1 )$$

where min( )is the minimum function which returns the smallest value in a set of elements, max( )is the maximum function which returns the largest value in a set of elements, log 10( ) is the logarithm in base 10 function, x is the input and a, b and w are parameters set by trial and error or by solving an optimization problem.

The left-most column of score blocks shown with respect to computing operation 312 represent various computed digital asset metrics. In general, these metrics quantify a quantity or quality of content that is provided (e.g., uploaded or otherwise created) by a common content creator. The first digital asset metric is represented by the R_{DMC} Count Score block. This score is calculated based on a total number of digital media assets (e.g., YouTube videos in one embodiment) that a content creator has made available (e.g., uploaded) that are included in the listing of R-DMCs returned via the subset of operations 302 (e.g., items identified as relevant to a brand or product of interest). If, for example, a YouTube channel contains “y” videos but only “x” of these videos are related to the brand of interest in a particular search, “x” is considered for calculating the R_{DMC} Count Score.

A second digital asset metric of the computing operations 312 is represented by the T_{DMC} Count Score block. This metric provides a score calculated based on the total number of digital media assets (e.g., YouTube video) that have been published (e.g., uploaded) by a content creator. If, for example, a YouTube channel contains “y” videos but only “x” number of them are related to the brand we are interested in, “y” is considered for calculating the T_{DMC} Count Score.

A third digital asset metric of the computing operations 312 is represented by the R_{DMC} T_{DMC} Count Score block. This metric represents a ratio of the number of related digital media content items (R_{DMC}, score) published by a content creator to the total number digital media content (T_{DMC} score) published by the same content creator. For example, this ratio may represent the number of brand-related videos published on a YouTube channel (e.g., a channel exclusively managed by a content creator) to the total number of YouTube videos published by the channel. As mentioned above, this metric may—in some implementations—be utilized to assist in initial filtering of content creators, such as during the sorting and filtering operation 309. In other implementations, filtering is not performed based on this metric.

A forth digital asset metric (shown at far right within the computing operations 312) is the R_{DMC}, Avg Len/Size Score. This metric quantifies the average length or size of related digital media content items published by a content creator. A production metric R_{DMC}, Ref Rate Score block may additionally be used to assign a score to each content creator (e.g., YouTube channel) based on the refresh rate (upload frequency) of the related digital media content items published by the content creator.

In addition to the digital asset metrics discussed above, the computing operation 312 may also calculate various traffic metrics (represented by the column adjacent and to the right of the digital asset column). The R_{DMC}, Traffic Score block represents a traffic metric quantifying total traffic associated with the related digital media content (R-DMC) items published by a content creator. In contrast, the T_{DMC}, Traffic Score block represents a traffic metric quantifying the total traffic resulting from all digital media content published by the content creator. The R_{DMC}/T_{DMC}Traffic Score block is metric usable to quantify a ratio of the traffic for a content creator resulting from related digital media content to the traffic resulting from all digital media content published by the content creator. The R_{DMC}, Avg Monthly Traffic Score block represents another traffic metric that quantifies the average monthly traffic resulting from related digital media content published by a content creator.

The computing operations 312 may also calculate various user engagement metrics that indicate how a user has reacted to or interacted with one or more of the R-DMC items. The R_{DMC}, Likes Score block represents a user engagement metric that quantifies number of likes resulting from related digital media content published by a content creator. The R_{DMC}, Dislike Score is, in contrast, a user engagement metric representing a number of dislikes resulting from the related digital media content published by the content creator. The R_{DMC}, Comments Score block represents another user engagement metric that quantifies a number of comments resulting from related digital media content published by the content creator.

The computing operation 312 also calculates one or more audience qualifier metrics, such as the Subscribers Score block. This metric generally quantifies a number of subscribers a content creator or channel has (if applicable). If, for example, the content creator is Joe of “Joe's YouTube Channel”, the subscribers score block may assign a score based on a number of users subscribed to receive content on this channel.

After calculating one or more of the scores described above with respecting to computing operations 312 for an individual content creator, digital content item, or subset of the related digital content item, an influence scoring operation 314 calculates an influence score (also referred to herein as a publisher score). The influence score may, in different implementations, be based on all, one, or any subcombination of the various digital asset metrics, traffic metrics, production metrics, audience qualifier metrics, and user engagement metrics described above.

In one implementation, an influence score is computed for different content creators in order to rank the content creators that create and/or publish digital content on the related digital media content items identified via the searching operations 302. One example influence score is calculated as the weighted average of all the values computed from each of the score blocks described above. In some cases, one or more of the values may be weighted, with weights determined during testing of the system, such as by using trial and error or using an automatic method until the final scores are deemed reasonable based on the feedback from users of the system.

A determination operation 316 determines whether there are any additional content creators to score. The process of calculating the influence score may be repeated for any content creator that has published at least one digital asset returned via the searching operations 302. A ranking operation 318 ranks a list of these content creators. This list may, for example, be offered to owners of the brand or product of interest for approaching potential collaborators, fans, or even influential publishers that create negative content about the brand. In one implementation, a transmittal operation 320 transmits for display the ranked listing or a listing of content creators associated with an influence score satisfying one or more predetermined criteria.

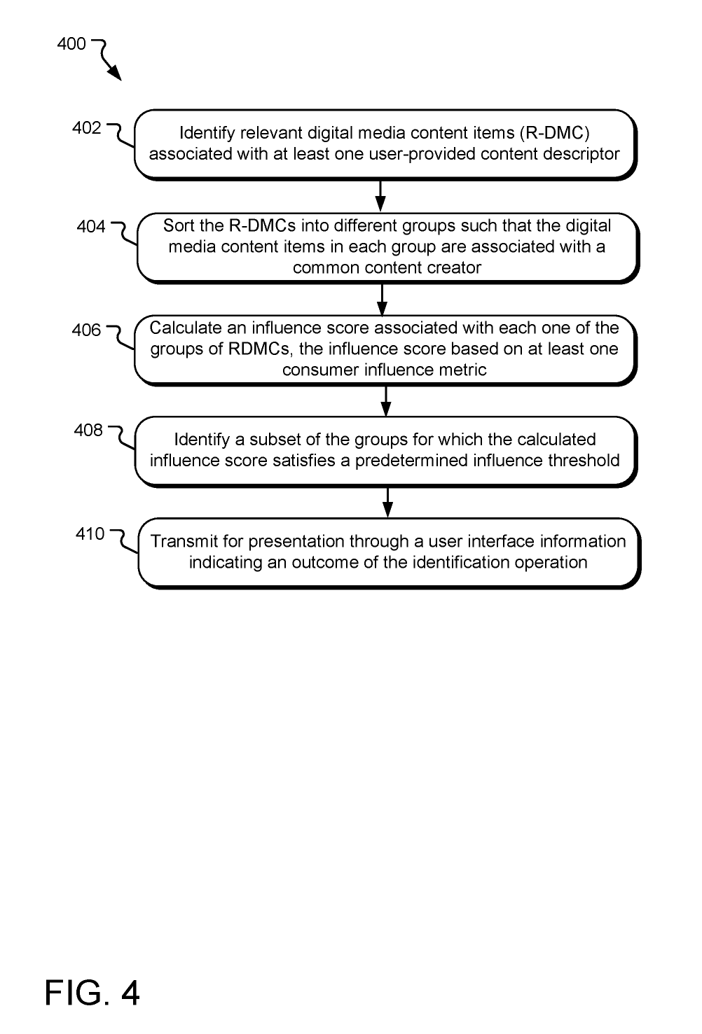

FIG. 4 illustrates example operations 400 for one embodiment of identifying influential content creators with respect to a particular product, brand, platform, idea, etc. An identification operation 402 identifies relevant digital media content items (R-DMC) associated with at least one user-provided content descriptor. A sorting operation 404 sorts the R-DMCs into different groups such that the digital media content items in each group are associated with a common content creator. A calculating operation 406 calculates an influence score associated with the common content creator for each different one of the sorted groups. The influence score is computed based on at least one consumer influence metric, such as a traffic metric quantifying views of one or more digital media content items in the group or views of other digital content items associated with the content creator. An identification operation 408 identifies a subset of the groups for which the calculated influence score satisfies a predetermined influence threshold, and a transmittal operation 410 transmits information to a user interface that indicates an outcome of the calculation operation 406 and the scoring operation 408. For example, the transmitted information may include content creator identifiers associated with each of the groups in the identified subset. In one implementation, the transmittal operations transmit ranked listing of content creators indicating an ascending or descending order of influence, as indicated by the associated influence score.

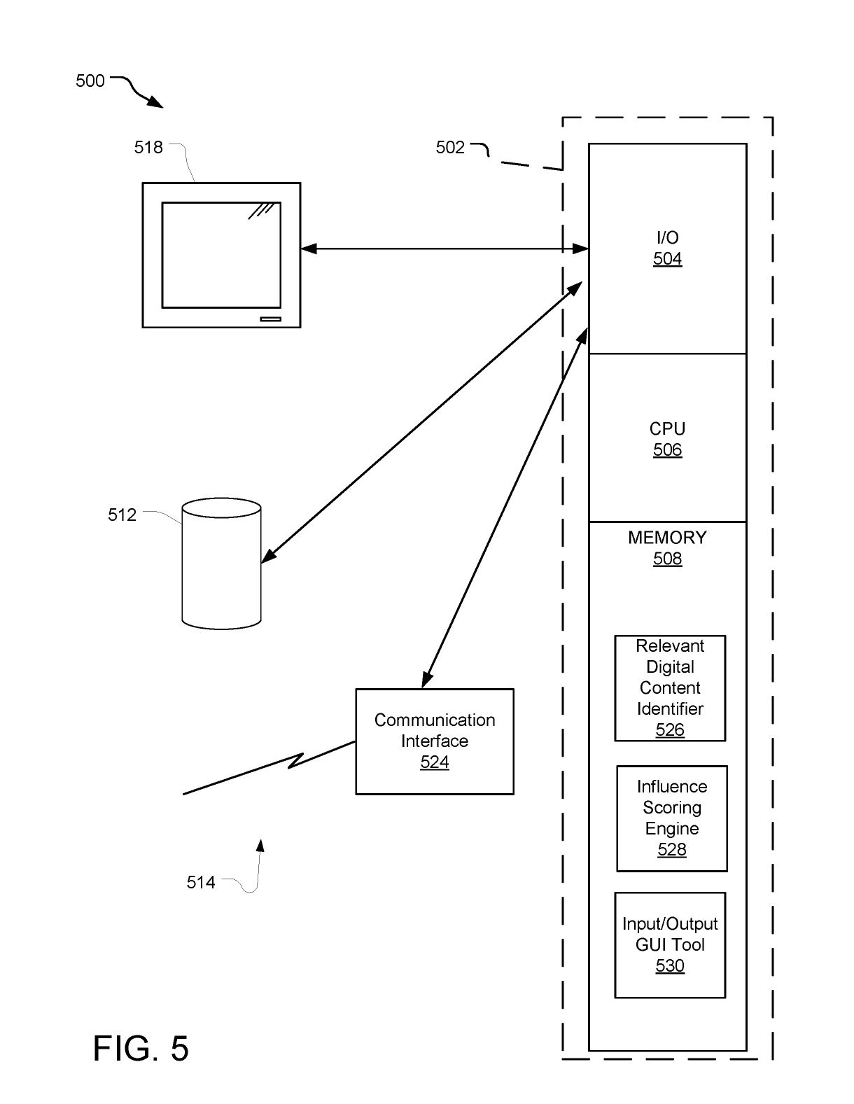

FIG. 5 discloses a block diagram of a computer system 500 suitable for implementing one or more aspects of system for digital content search and market influence analysis. The computer system 500 is capable of executing a computer program product embodied in a tangible computer-readable storage medium to execute a computer process. Data and program files may be input to the computer system 500, which reads the files and executes the programs therein using one or more processors. Some of the elements of a computer system 500 are shown in FIG. 5 wherein a processor 502 is shown having an input/output (I/O) section 504, a Central Processing Unit (CPU) 506, and a memory section 508. There may be one or more processors 502, such that the processor 502 of the computing system 500 comprises a single central-processing unit 506, or a plurality of processing units. The processors may be single core or multi-core processors. The computing system 500 may be a conventional computer, a distributed computer, a computer or group of computers as a part of a cloud computing service or any other type of computer. The described technology is optionally implemented in software loaded in memory 508, a storage unit 512, and/or communicated via a wired or wireless network link 514 on a carrier signal (e.g., Ethernet, 3G wireless, 4 G wireless, LTE (Long Term Evolution)) thereby transforming the computing system 500 in FIG. 5 to a special purpose machine for implementing the described operations.

The I/O section 504 may be connected to one or more user-interface devices (e.g., a keyboard, a touch-screen display unit 518, etc.) or a storage unit 512. Computer program products containing mechanisms to effectuate the systems and methods in accordance with the described technology may reside in the memory section 508 or on the storage unit 512 of such a computer system 500.

A communication interface 524 is capable of connecting the computer system 500 to a network via the network link 514, through which the computer system can receive instructions and data embodied in a carrier wave. When used in local area networking (LAN) environment, the computing system 500 is connected (by wired connection or wirelessly) to a local network through the communication interface 524, which is one type of communications device. When used in a wide-area-networking (WAN) environment, the computing system 500 typically includes a modem, a network adapter, or any other type of communications device for establishing communications over the wide area network. In a networked environment, program modules depicted relative to the computing system 500 or portions thereof, may be stored in a remote memory storage device. It is appreciated that the network connections shown are examples of communications devices for and other means of establishing a communications link between the computers may be used.

In an example implementation, a relevant digital content identifier 526, influence scoring engine 528, and input/output GUI tool 530 and other modules are embodied by instructions stored in memory 508 and/or the storage unit 512 and executed by the processor 502.

One or more relational databases storing digital content metadata and/or digital content items searchable by the relevant digital content identifier may be stored in the disc storage unit 512 or other storage locations accessible by the computer system 500, such as across a wide area network (WAN) or a local area network (LAN) or a private cloud. In addition, the computer system 500 may utilize a variety of tools to mine and process digital media content and related metadata such as one or more knowledge base systems accessible across a network and/or various database query tools, such as tools provided one or more digital media sharing websites. A market influence analysis engine and/or any of its associated submodules (e.g., an input/output GUI tool, a relevant digital content identifier, a sorting engine, or an influence scoring engine) may be implemented using a general-purpose computer and specialized software (such as a server executing service software), a special purpose computing system and specialized software (such as a mobile device or network appliance executing service software), or other computing configurations. In addition, modules of a market influence analysis engine may be stored in the memory 508 and/or the storage unit 512 and executed by the processor 502.

The implementations of the invention described herein are implemented as logical steps in one or more computer systems. The logical operations of the present invention are implemented (1) as a sequence of processor-implemented steps executing in one or more computer systems and (2) as interconnected machines or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, adding and omitting as desired, unless explicitly claimed otherwise or a specific order is inherently necessitated by the claim language.

The above specification, examples, and data provide a complete description of the structure and use of exemplary embodiments of the invention. Since many implementations of the invention can be made without departing from the spirit and scope of the invention, the invention resides in the claims hereinafter appended. Furthermore, structural features of the different implementations may be combined in yet another implementation without departing from the recited claims.

1. One or more computer-readable storage media encoding computer-executable instructions for executing on a computer system a computer process, the computer process comprising:
identifying digital media content items associated with at least one user-provided content descriptor;
sorting the identified digital media content items into different groups such that the digital media content items in each group are associated with a different one of a plurality of content creators;
calculating an influence score associated with each one of the plurality of content creators, the influence score based on consumer influence metrics quantifying user engagement with or user exposure to one or more digital media content items in the associated group;
identifying a subset of the plurality of content creators for which the calculated influence score satisfies a predetermined influence threshold; and
transmitting for presentation through a user interface the identified subset of content creators.

2. The one or more computer-readable storage media of claim 1,
wherein the content descriptor is descriptive of a brand or product of interest and identifying the digital media content items associated with the content descriptor of interest further comprises:
receiving from a keyword suggestion tool a listing of entity descriptors associated in a database with the content descriptor;
presenting the listing of entity descriptors on a graphical user interface;
receiving a selected subset of the entity descriptors from the listing, the selected subset identified by a user as relevant to the brand or product of interest;
querying a database with the selected subset of the entity descriptors to identify digital media content items related to one or more entities of the selected subset.

3. The one or more computer-readable media of claim 1, wherein the consumer influence metrics include a traffic metric quantifying total views of all digital content items provided by a content creator.

4. The one or more computer-readable media of claim 1, wherein the consumer influence metrics include an asset metric that quantifies a fraction of total digital content assets provided by a content creator.

5. The one or more computer-readable media of claim 1, wherein the asset metric further quantifies a fraction of total digital content assets provided by the content creator that are also identified in association with the at least one user-provided content descriptor .

6. The one or more computer-readable media of claim 1, wherein the consumer influence metrics further include a user engagement metric that quantifies user engagement signals associated with a content creator or the content generated by that content creator.

7. The one or more computer-readable media of claim 1, wherein the consumer influence metrics further include an audience qualifier metric that further quantifies a number of subscribers to a channel or social media account associated with a content creator.

8. The one or more computer-readable media of claim 7, wherein the audience qualifier metric qualifies demographics of subscribers or followers of a particular digital content channel or social media account.

9. The one or more computer-readable media of claim 1, wherein the consumer metrics further include a production metric that quantifies frequency of digital content publications associated with a content creator.

10. The one or more computer-readable media of claim 1, wherein the predetermined influence threshold is indicative of a high degree of consumer influence.

11. A system comprising:
memory;
at least one processor;
a market influence analysis engine stored in the memory and executable by the at least one processor to:
identify digital media content items associated with at least one user-provided content descriptor;
sort the identified digital media content items into different groups such that the digital media content items in each group are associated with a different one of a plurality of content creators;
calculate an influence score associated with each one of the plurality of content creators, the influence score based on consumer influence metrics quantifying user engagement with or user exposure to one or more digital media content items in the associated group;
identify a subset of the plurality of content creators for which the calculated influence score satisfies a predetermined influence threshold; and
transmit for presentation through a user interface the identified subset of content creators.

12. The system of claim, 11 wherein the relevant digital content identifier is further executable to:
receive from a keyword suggestion tool a listing of entity descriptors associated in a database with the content descriptor;
present the listing of entity descriptors on a graphical user interface;
receive a selected subset of the entity descriptors from the listing, the selected subset identified by a user as relevant to the brand or product of interest; and
query a database with the selected subset of the entity descriptors to identify digital media content items related to one or more entities of the selected subset.

13. The system of claim 11, wherein the influence metrics include a traffic metric that quantifies total views of all digital content items provided by a content creator.

14. The system of claim 11, wherein the consumer influence metrics further include an asset metric that quantifies a fraction of total digital content assets provided by a content creator.

15. The system of claim 11, wherein the asset metric further quantifies a fraction of total digital content assets provided by the content creator that are also identified in association with the at least one user-provided content descriptor.

16. The system of claim 11, wherein the consumer influence metrics further include a user engagement metric that quantifies user engagement signals associated with a content creator or the digital media content items in an associated one of the identified groups.

17. The system of claim 11, wherein the consumer influence metrics further include an audience qualifier metric that quantifies a number of subscribers to a channel associated with a content creator.

18. The system of claim 11, wherein the audience qualifier metric qualifies demographics of subscribers to a particular digital content channel.

19. The system of claim 11, wherein the consumer metrics include a production metric that quantifies frequency of digital content publications associated a content creator.

20. The system of claim 11, wherein the consumer metrics include at least one metric quantifying nudity or vulgarity of the identified digital media content items provided by a content creator.

21. One or more computer-readable storage media encoding computer-executable instructions for executing on a computer system a computer process, the computer process comprising:
identifying digital media content items associated with at least one user-provided content descriptor;
sorting the identified digital media content items into different groups such that the digital media content items in each group are associated with a different one of a plurality of content creators;
calculating an influence score associated with each one of the plurality of content creators, the influence score of each group based on consumer influence metrics quantifying user engagement with or user exposure to one or more digital media content items in the associated group; and
transmitting for presentation through a user interface information identifying a subset of the groups for which the calculated influence score satisfies a predetermined threshold.
